(19) United States
(12) Patent Application Publication
(10) Pub. No.: US 2007/0028735 A1
(43) Pub. Date: Feb. 8, 2007

(54) Cutting device

(76) Inventors: Hartmut Brodbek, Stuttgart (DE); Wolfgang Schneider, Stuttgart (DE); Wofgang Drefs, Huttlingen (DE)

Correspondence Address: VOITH FABRICS, 3040 BLACK CREEK ROAD, P.O. BOX 1411, WILSON, NC, 27893, US

(21) Appl. No.: 11/409,252

(22) Filed: Apr. 21, 2006

(30) Foreign Application Priority Data
Apr. 22, 2005 (DE) 10 2005 018 767.6

(51) Int. Cl. B26D 7/06

(52) U.S. Cl. 83/98

(57) ABSTRACT

The invention relates to a cutting device having a cutting unit for dividing a strip from a material web running in a transport direction relative to the cutting device, and having a base support that defines a cutting section for supporting the material web during the division of the strip, and a supporting section, the supporting section being formed and arranged in such a way that it supports the material web and the strip as they are transported away out of the cutting section in the transport direction, wherein the supporting section has a cutout which extends and is formed in such a way that the cut edge of the material web and/or the cut edge of the strip are not supported on the supporting section, at least in some sections, as they are transported away out of the cutting section.

### CROSS-REFERENCE TO RELATED APPLICATIONS

The present application claims priority under 35 U.S.C. §119 of German Patent Application No. 10 2005 018 767.6 filed on Apr. 22, 2005, the disclosure of which is expressly incorporated by reference herein in its entirety.

### BACKGROUND OF INVENTION

1. Field of the Invention

This invention relates to a cutting device for dividing a strip from a material web moving in a transport direction relative to the cutting device, according to the preamble of patent claim 1.

2. Discussion of Background Information

Such cutting devices are generally found in machines for the production and/or further processing of a material web, in particular a fibrous web such as paper, board or tissue, in order preferably to divide an edge strip running parallel to the longitudinal extent of the material web from the material web. Such cutting devices normally have a cutting unit which, for example, produces a cutting jet which acts on the edge of the material web in order to divide off the edge strip.

During division, the material web must be supported by a base support in order not to be able to escape the cutting force. In such cutting devices, the base support is normally formed in such a way that, after the cutting, the material web and the strip divided off can be carried away in a defined manner from the cutting point supported on said base support. The edge strip divided off is usually separated from the material web after being carried away from the cutting point or even while being carried away from the cutting point and is led into a duct for disposal.

During the division of the strip from the material web, cut material is produced in the region of the cut edge of the material web and the cut edge of the strip, which is partly carried along by said strip and partly deposited on the base support. The deposits of cut material on the base support can lead to disruption to the transport of the cut material web, with the consequence that the material web tears and the production process has to be interrupted.

### SUMMARY OF THE INVENTION

It is the object of the present invention to propose a cutting device in which the probability of deposits of cut material on the base support is minimized.

The generic cutting device has a cutting unit for dividing a strip from a material web running in a transport direction relative to the cutting device and a base support. The base support has a cutting section for supporting the material web during the division of the strip, and a supporting section. The supporting section is formed and arranged in such a way that it supports the material web and the strip as they are transported away out of the cutting section in the transport direction.

In the case of the cutting device according to the invention, provision is moreover made for the supporting section to have a cutout which extends and is formed in such a way that the cut edge of the material web and/or the cut edge of the strip is/are not supported on the supporting section, at least in some sections, as they are transported away out of the cutting section.

In this way, although the material web and the strip divided off can be transported away out of the cutting section supported in a defined manner, as a result of the provision of the cutout, either one or both cut edges carrying the cut material with them, that is to say the cut edge of the material web and of the strip, are not supported or guided on the base support, at least in some sections, which means that the risk of the deposition of cut material on the base support is minimized or prevented and thus no production disruptions as a result of web breaks occur.

Advantageous refinements and developments of the invention are specified in the subclaims.

The cutout preferably extends in the envisaged transport direction of the material web, which means that the cut edge of the material web and/or the cut edge of the strip are not supported on the supporting section, at least in some sections, as they are transported, oriented in the transport direction, away out of the cutting section.

According to a preferred embodiment, the cutting unit comprises means for producing a cutting jet, which is aimed at the material web in the cutting section. The use of a cutting jet has proven to be advantageous in particular when cutting material webs since, in this case, the means which produce the jet, for example a laser or high-pressure water jet device, can be arranged at a great distance from the material web. Furthermore, a particularly accurate cut can be achieved with a cutting jet.

In order to divide a strip from a material web formed as a fibrous web, use is preferably made of a fluid jet, for which reason a fluid jet is advantageously produced by the means. This fluid jet can be formed from a gaseous medium or from a liquid medium or from a combination of a gaseous and a liquid medium.

For other types of material webs, such as plastic films or metal foils, for the purpose of division use is made of a light beam, for example a laser beam, for which reason, according to a further embodiment, provision is made for a light beam to be produced by the means.

During the division of the strip, cut material accumulates in the cutting section, which has to be carried away from the cutting section in order to prevent disruptions. If, for example, the cutting jet used is moreover a fluid jet, then this must likewise be carried away from the cutting section. A preferred refinement of the invention therefore provides for the cutting section of the base support to have a jet opening for the passage of the cutting jet after the cutting of the strip from the material web and of a part of the cut material.

In order to increase the efficiency of carrying away the cut material and the fluid cutting jet following the division of the strip from the material web, provision can be made for a pipe to be provided in the region of the jet opening on the side of the base support facing away from the material web, said pipe being formed and arranged in such a way that the cutting jet and cut material passing through the jet opening are intercepted by said pipe. The pipe can optionally be under vacuum, so that the cutting jet and the cut material are sucked into the pipe.

In order to prevent as far as possible the deposition of the cut material as a result of contact of the cutting edges with the supporting section of the base support, provision is made for the cutout to extend onward from the jet opening.

According to a further preferred embodiment of the invention, provision is made for the cutout to be formed as an opening in the base support. In this way, the deposition of cut material is reduced further, since the latter can fall through the opening in the supporting section and thus cannot accumulate on the supporting section of the base support.

Provision is preferably made for the cutout formed as an opening to merge into the jet opening. In this way, the deposition of cut material is prevented, starting in the cutting section.

According to a further refinement of the invention, the supporting section comprises a separation region which is formed to separate the strip divided off from the material web. Furthermore, a duct is preferably provided, which is arranged in relation to the separation region in such a way that the separated strip is guided from the separation region into the duct.

One practical refinement of the invention provides for the supporting section to comprise a guide region, which is arranged before the separation region in the envisaged transport direction of the material web, the separation region extending at an angle relative to the guide region. In this case, the separation region extends pointing downward in the transport direction.

In order to prevent the strip divided off from folding over, the separation region is formed in such a way that the cut edge of the strip is supported on the latter, at least in some sections.

The material web is preferably a fibrous web, in particular a paper, board or tissue web.

According to a further refinement of the invention, provision is made for the transport direction of the material web to be parallel to the longitudinal extent of the material web. This makes it possible to divide off from the material web a strip parallel to the longitudinal extent.

In order to increase the wear resistance of the cutting device, provision is made for the cutting section and/or the supporting section and/or the guide region to consist wholly or partly of a wear-resistant material, in particular to be wholly or partly coated with a hard material, such as diamond.

The cutting device according to the invention is preferably used in a machine for the production and/or processing of a fibrous web.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a cutting device disclosed by the prior art in a perspective view,

FIG. 2 shows a first embodiment of a cutting device according to the invention in a perspective view.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

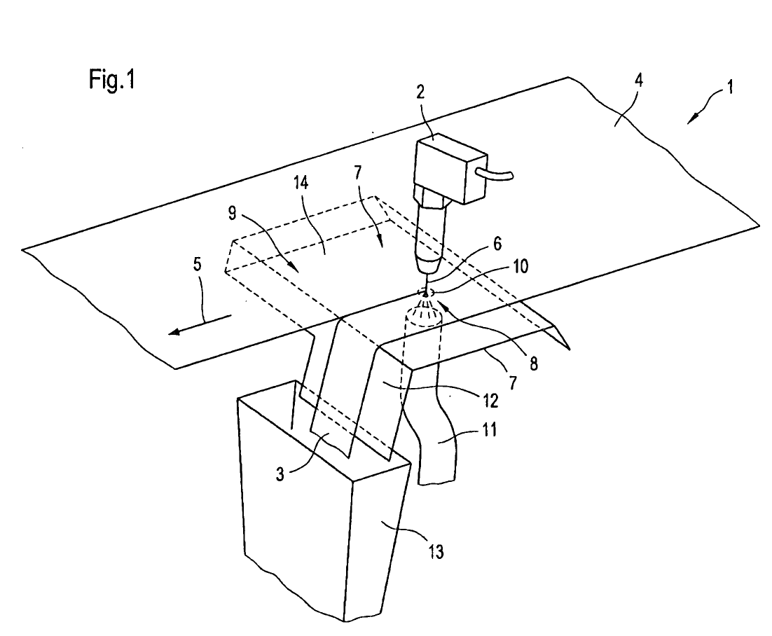

FIG. 1 shows a cutting device 1 disclosed by the prior art.

The cutting device 1 has a cutting unit 2 for dividing a strip 3 from a material web 4 running in a transport direction 5 relative to the cutting device 1. The transport direction 5 of the material web 4 runs parallel to the longitudinal extent of the material web 4.

In the present case, the cutting unit 2 has means for producing a fluid jet 6. Furthermore, the cutting device 1 has a base support 7 that defines a cutting section 8 for supporting the material web 4 during the division of the strip 3, and a supporting section 9, the supporting section 9 being formed and arranged in such a way that it supports the material web 4 and the strip 3 as they are transported away out of the cutting section 8 in the transport direction 5. In practical terms in the present case, this means that the supporting section 9 is arranged after the cutting section 8 in the transport direction 5.

As can be seen from FIG. 1, in the region of the cutting section 8 there is arranged a jet opening 10 for the passage of the cutting jet 6 following the division of the strip 3 from the material web 4. Furthermore, a pipe 11 is provided in the region of the jet opening 10 on the side of the base support 7 facing away from the material web 4, said pipe being formed and arranged in such a way that the cutting jet 6 and cut material are intercepted by said pipe.

Furthermore, the supporting section 9 comprises a separation region 12, which is formed to separate the strip 3 divided off from the material web 4. The separation region 12 is assigned a duct 13, which is arranged in relation to the separation region 12 in such a way that the separated strip 3 is guided from a separation region 12 into the duct 13. In practical terms, the supporting section 9 comprises a guide region 14, which is arranged before the separation region 12 in the transport direction 5. The guide region 14 runs substantially horizontally, whereas the separation region 12 extends downward at an angle relative to the guide region 14.

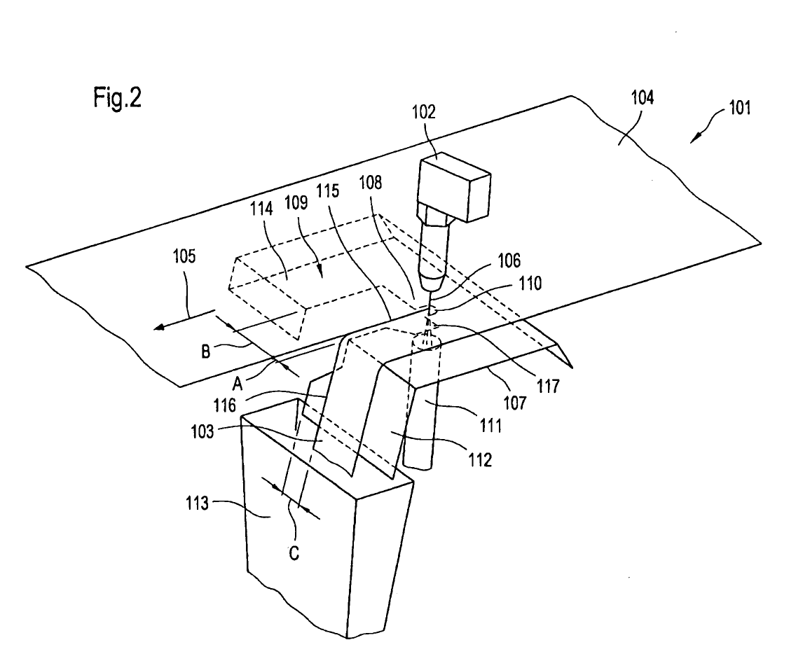

FIG. 2 shows a cutting device 101 according to the invention.

The cutting device 101 has a cutting unit 102 for dividing a strip 103 from a material web 104 running in a transport direction 105 relative to the cutting device 101. In the present case, the cutting unit 102 has means for producing a fluid jet 106. In the present case, the material web is a fibrous web, such as a paper web, the transport direction 105 of the material web 104 running parallel to the longitudinal extent of the material web 104.

The cutting unit 101 has a base support 107 that defines a cutting section 108 for supporting the material web 104 during the division of the strip 103, and a supporting section 109, the supporting section 109 being formed and arranged in such a way that it supports the material web 104 and the strip 103 as they are transported away out of the cutting section 108 in the transport direction 105. In practical terms in the present case, this means that the supporting section 109 is arranged after the cutting section 108 in the transport direction 105.

In the embodiment illustrated, the cutting section 108 is partly coated with hard material, for example coated with diamond, in order to increase the wear resistance of the base support 107 in this region.

During the cutting of the material web 104, cut edges 115 and 116 extending in the transport direction 105 of the material web 104 are formed in the material web 104 and the strip 103. In the case of the cutting device 101 according to the invention, the base support 107 has in the supporting section 109 a cutout 117 which is formed as an opening which extends and is formed in such a way that the cut edge 115 of the material web 104 and the cut edge 116 of the strip 103 are not supported on the supporting section 109 in some sections as they are transported away out of the cutting section 108. In practical terms, the opening 117 extends in the transport direction 105 of the material web 104 and directly adjoins a jet opening 110 for the passage of the cutting jet 106 arranged in the region of the cutting section 108.

Furthermore, as in the known cutting device 1, a pipe 111 is provided in the region of the jet opening 110 on the side of the base support 107 facing away from the material web 104, said pipe being formed and arranged in such a way that the cutting jet 106 and cut material are intercepted by said pipe.

In the present exemplary embodiment, the supporting section 109 is formed by a guide region 114 extending horizontally and a separation region 112 following the latter in the transport direction 105 and extending obliquely downward relative thereto, which is designed to separate the strip 103 divided off from the material web 104 and to feed it to a duct 113 assigned to the separation region 112. The separation region 112 is formed in such a way that the cut edge 116 of the strip 103 is supported on the latter, whereas, according to the invention, the cut edge 116 of the strip 103 is not supported by the base support 107 on account of the opening 117 in the guide region 114 running horizontally.

In practical terms, the opening in the base support 107 in the supporting region is formed in such a way that the cut edge 115 of the material web 104 in the guide region 114 projects beyond the guide region 114 by the amount B and that the cut edge 116 of the strip 103 in the guide region 114 projects beyond the guide region 114 by the amount A, so that the two cut edges 115 and 116 are not supported in the guide region 114, whereas the cut edge 116 of the strip 103 is supported in the separation region 112, since here the separation region 112 projects beyond the cut edge 116.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present extends to all functionally equivalent structures, methods and uses, such as are within the scope of the appended claims.

1-19. (canceled)

20. A cutting device comprising:
a cutting unit that divides a strip from a material web running in a transport direction relative to the cutting device;
a base support that defines a cutting section that supports the material web during the division of the strip;
a supporting section, the supporting section formed and arranged in such a way that the supporting section supports the material web and the strip as they are transported away out of the cutting section in the transport direction,
wherein the supporting section further comprises a cutout that extends and is formed in such a way that at least one of a cut edge of the material web and the cut edge of the strip is not supported on at least one section of the supporting section as they are transported away out of the cutting section.

21. The cutting device as claimed in claim 20, wherein the cutout extends in the transport direction of the material web.

22. The cutting device of claim 20, wherein the cutting unit comprises means for producing a cutting jet aimed at the material web in the cutting section.

23. The cutting device of claim 22, wherein a fluid jet is produced by the means for producing a cutting jet.

24. The cutting device of claim 23, wherein the fluid jet is formed by at least on of a gaseous medium and a liquid medium.

25. The cutting device of claim 22, wherein a light beam is produced by the means for producing a cutting jet.

26. The cutting device of claim 22, wherein the cutting section has a jet opening for the passage of the cutting jet.

27. The cutting device of claim 26, further comprising a pipe, the pipe provided in the region of the jet opening on a first side of a base support facing away from the material web, the pipe being formed and arranged in such a way that the cutting jet and cut material are intercepted by said pipe.

28. The cutting device of claim 26, wherein a cutout extends onward from the jet opening.

29. The cutting device of claim 28, wherein the cutout is formed as an opening in the base support.

30. The cutting device of claim 29, wherein the cutout formed as an opening merges into the jet opening.

31. The cutting device of claim 20, wherein the supporting section comprises a separation region that separates the strip divided off from the material web.

32. The cutting device of claim 31, further comprising a duct, the duct arranged in relation to the separation region in such a way that the separated strip is guided from the separation region into the duct.

33. The cutting device of claim 31, wherein the supporting section comprises a guide region, the guide region arranged before the separation region in the transport direction, the separation region extending at an angle relative to the guide region.

34. The cutting device of claim 31, wherein the separation region is formed in such a way that the cut edge of the strip is supported on the latter, at least in some sections.

35. The cutting device of claim 20, wherein the material web is one of a fibrous web, a paper web, a board web and a tissue web.

36. The cutting device of claim 20, wherein the transport direction of the material web is parallel to the longitudinal extent of the latter.

37. The cutting device of claim 20, wherein at least one of the cutting section, the supporting section and the guide region consist at least one of wholly and partly of a wear-resistant material.

38. The cutting device of claim 37, wherein the wear-resistant material is one of a hard material and diamond.

39. A machine for at least one of production and processing of a fibrous web, comprising the cutting device of claim 20.
